(19) United States
(12) Patent Application Publication
(10) Pub. No.: US 2021/0389129 A1
(43) Pub. Date: Dec. 16, 2021

(54) METHOD AND SYSTEM OF EVALUATING A CONSTELLATION SPARE STRATEGY BASED ON A STOCHASTIC TIME PETRI NET

(71) Applicant: Space Engineering University, Beijing (CN)

(72) Inventors: Min Hu, Beijing (CN); Xuyu Wang, Beijing (CN); Qiang Li, Beijing (CN); Jiuyang Li, Beijing (CN); Feifei Li, Beijing (CN); Yulong Zhao, Beijing (CN); Rui Zhang, Beijing (CN); Tun Wu, Beijing (CN)

(21) Appl. No.: 17/346,190

(22) Filed: Jun. 11, 2021

(30) Foreign Application Priority Data
Jun. 16, 2020 (CN) 202010551432.7

(51) Int. Cl. G01C 21/02; G06F 30/22; B64G 1/10; B64G 1/66

(52) U.S. Cl. CPC G01C 21/025; G06F 30/22; G06F 2111/08; B64G 1/66; B64G 1/10

(57) ABSTRACT

Provided is a method and system of evaluating a constellation spare strategy based on a stochastic time Petri net, which is applied in the technical field of constellation operation management. The method comprises: constructing a single satellite STPN model and an orbital plane STPN model, and establishing a navigation constellation STPN model that includes multiple spare strategies according to the single satellite STPN model and the orbital plane STPN model; establishing an availability model according to the number of malfunctioning satellites and the constellation value (CV) in the navigation constellation STPN model, and establishing a cost model according to operating costs of the navigation constellation STPN model; and evaluating the navigation constellation STPN model using the availability model and the cost model, and determining a target spare strategy from the multiple spare strategies according to an evaluation result.

### CROSS-REFERENCE TO RELATED APPLICATIONS

This application claims the priority of Chinese patent application No. 202010551432.7, entitled “method and system for evaluating a constellation spare strategy based on a stochastic time Petri net” and filed on Jun. 16, 2020, the entirety of which is incorporated herein by reference.

### FIELD OF THE INVENTION

The present disclosure relates to the technical field of constellation operation management, and in particular, to a method and system of evaluating a constellation spare strategy based on a stochastic time Petri net.

### BACKGROUND OF THE INVENTION

As a complex space system, the operation and management of a navigation constellation is faced with many challenges. During the operation of the navigation constellation, due to the limitations of their own lifetime and reliability, as well as the impact of complex and harsh space environment, satellites will undergo a short-term malfunction (a recoverable malfunction) or a long-term malfunction (an unrecoverable malfunction), thereby causing the decline of constellation service performance Therefore, in order to meet the strict requirements on the availability, continuity and integrity of a navigation constellation system, different spare strategies need to be adopted according to its actual conditions, so that the functions of the constellation can be recovered in the shortest possible time, when the satellites in the constellation malfunction. According to the experience in the construction and operation of three global satellite navigation systems, namely Global Positioning System (GPS), Global Navigation Satellite System (GLONASS) and Galileo, a constellation spare strategy which is of great significance for realizing the continuous and stable operation of the constellation, is an important part of the constellation design of a global navigation satellite system.

In the related technologies, the constellation spare strategy is studied by establishing a model. For example, the Markov method is adopted to establish a constellation model to study the constellation spare strategy; the Bayesian network is used to establish an availability model of the constellation system, and a reasonable constellation spare strategy is proposed according to the requirements on the availability model; the constellation is modeled using a multi-level inventory theory for large communication satellites, and an optimized spare strategy based on characteristics of the parking orbit and a location strategy is proposed, etc. However, due to the complexity of the constellation system, the establishment of the constellation model is faced with problems such as state space explosion and resource allocation. Furthermore, during the research in the related technologies, the constellation model is simplified to facilitate the problem analysis, and meanwhile a single index is also adopted mostly for the evaluation of the constellation spare strategy, which is not conducive to the optimization design of the constellation spare strategies.

### SUMMARY OF THE INVENTION

The present disclosure provides a method and system of evaluating a constellation spare strategy based on a stochastic time Petri net, thereby at least to some extent overcoming the unreasonable problem of an optimization design of the constellation spare strategy in the related technologies, and provides a basis for the design of a constellation system structure and parameter selection.

An aspect of the present disclosure provides a method of evaluating constellation spare strategy based on a stochastic time Petri net, comprising:

constructing a single satellite STPN model (Stochastic Timed Petri Nets, a model based on a stochastic time Petri net) and an orbital plane STPN model, and establishing a navigation constellation STPN model that includes multiple spare strategies according to the single satellite STPN model and the orbital plane STPN model;

establishing an availability model according to the number of malfunctioning satellites and the constellation value (CV) in the navigation constellation STPN model, and establishing a cost model according to operating costs of the navigation constellation STPN model; and

evaluating the navigation constellation STPN model using the availability model and the cost model, and determining a target spare strategy from the multiple spare strategies according to an evaluation result.

Another aspect of the present disclosure provides a system for evaluating a constellation spare strategy based on a stochastic time Petri net, comprising:

a first model establishment module, configured to construct a single satellite STPN model and an orbital plane STPN model, and establish a navigation constellation STPN model that includes multiple spare strategies according to the single satellite STPN model and the orbital plane STPN model;

a second model establishment module, configured to establish an availability model according to the number of malfunctioning satellites and the CV in the navigation constellation STPN model, and establish a cost model according to the operating costs of the navigation constellation STPN model; and

a spare strategy determination module, configured to evaluate the navigation constellation STPN model using the availability model and the cost model, and determine a target spare strategy from the multiple spare strategies according to an evaluation result.

The method provided by the present disclosure involves constructing a three-layer STPN model of a single satellite, an orbital plane and a navigation constellation by considering various deterministic and stochastic factors of system operation, and analyzing the characteristics of the logical behavior of constellation operation and the time-sequence relationship of operation events under different spare strategies, thereby more accurately describing the characteristics of the internal logical structure of a constellation and the supply process of spare parts, which improves the accuracy of the spare strategy evaluation.

The method provided by the present disclosure comprehensively considers the availability of the constellation and the operating costs of the system to obtain an optimal spare strategy of the constellation under different conditions with a standard of a minimum cost on the basis of meeting the availability, which provides a reference for a design of the spare strategy of the navigation constellation.

The method provided by the present disclosure allows the design of different spare strategies, and fully evaluates the impact of different spare strategies on operating parameters of the constellation according to the number of on-orbit and ground spare satellites, as well as a launch mode of spare satellites, in terms of an on-orbit spare strategy, a ground spare strategy, and a combination of two spare strategies. The method is more flexible.

### BRIEF DESCRIPTION OF THE DRAWINGS

The drawings herein are incorporated into the description, and constitute one part of the description. The drawings show embodiments that conform to the present disclosure, and are used for interpreting the principle of the present disclosure together with the description. Obviously, the drawings in the following descriptions are only related to some embodiments of the present disclosure. For those of ordinary skill in the art, other drawings can further be obtained based on these drawings without exercising the inventive effort.

FIG. 1 shows a flowchart of a method of evaluating a constellation spare strategy based on a stochastic time Petri net according to an embodiment of the present disclosure;

FIG. 2 shows a single satellite STPN model according to an embodiment of the present disclosure;

FIG. 3 shows the orbital plane STPN model according to an embodiment of the present disclosure;

FIG. 4 shows the navigation constellation STPN model according to an embodiment of the present disclosure;

FIG. 5 shows a graph of changes in satellite reliability after the operation of the system according to an embodiment of the present disclosure;

FIG. 6 shows a graph of changes in probability with the number of spare satellites on the ground without on-orbit spare satellites according to an embodiment of the present disclosure;

FIG. 7 shows a graph of changes in probability with the number of spare satellites on the ground when each orbital plane is backed up with one satellite according to an embodiment of the present disclosure;

FIG. 8 shows graphs of changes in probability with the number of spare satellites on the ground when each orbital plane is backed up with two satellites according to an embodiment of the present disclosure;

FIG. 9 shows graphs of changes in the operating costs of the system with the number of spare satellites on the ground according to an embodiment of the present disclosure; and

FIG. 10 shows a structural block diagram of a system for evaluating a constellation spare strategy based on a stochastic time Petri net according to an embodiment of the present disclosure.

### DETAILED DESCRIPTION OF THE EMBODIMENTS

In order to make objectives, technical solutions, and beneficial effects of the present disclosure clearer, the present disclosure will be explained in details with reference to the drawings and the embodiments as below. It should be noted that the specific embodiments described here are only used to explain the present disclosure, but not used to limit the present disclosure.

A Petri net is a kind of a net information flow model, which includes two types of nodes, namely a place and a transition; at the same time, a token distribution (identifier) representing state information is added to the place set; and in the embodiments of the present disclosure, the place represents an operating state of the system, and the transition represents an operation or event in system movement.

The Petri net which serves as a modeling mechanism suitable for describing and analyzing a system with features such as concurrency, synchronization, and conflict, is widely used in various fields due to its intuitionistic graphical representation ability and strict mathematical foundation. A basic Petri net is mainly used for describing the operating logic in the system and reflecting the static layout and dynamic changes of the system. The limitation of the basic Petri net lies in that it can only perform qualitative analysis. However, in order to use it for analyzing the quantitative characteristics of the system, the concept of time must be introduced. A time Petri net is obtained by introducing a time variable into the Petri net, and when the time introduced is a random variable, the time Petri net is called a Stochastic Timed Petri net (STPN). An STPN model that includes an instantaneous transition, a deterministic transition, an exponential transition, and other generally distributed transition, greatly enhances the modeling capability of the Petri net and the system range that can be modeled. It may quantitatively calculate various performance indicators, and provides a basis for a design of a system structure and the selection of parameters.

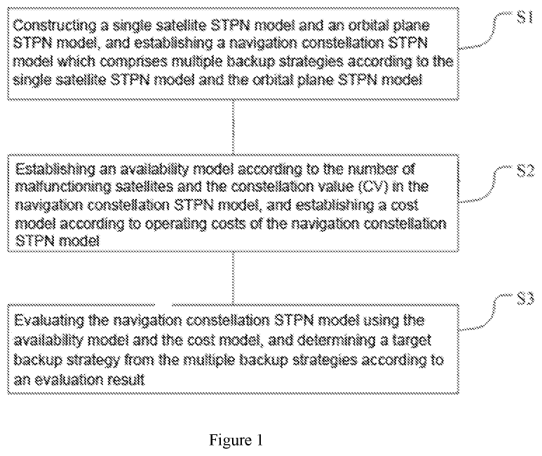

Based on this, the present disclosure firstly provides a method of evaluating a constellation spare strategy based on a stochastic time Petri net. FIG. 1 shows a flowchart of the method of evaluating a constellation spare strategy based on a stochastic time Petri net according to an embodiment of the present disclosure. The following detailed interpretations are conducted on the method of evaluating a constellation spare strategy based on a stochastic time Petri net according to this embodiment with reference to FIG. 1.

Step S1: a single satellite STPN model and an orbital plane STPN model are constructed, and a navigation constellation STPN model including multiple spare strategies is established according to the single satellite STPN model and the orbital plane STPN model.

In this implementation, the single-satellite STPN model simulates a process of malfunctioning and repairing during the lifetime of the satellite; the orbital plane STPN model describes a process of replacing the malfunctioning satellite with an on-orbit spare satellite and sending a launch request to the ground system. The navigation constellation STPN model includes a space subsystem and a ground subsystem, and the space subsystem includes a single satellite STPN model and an orbital plane STPN model. The ground subsystem includes the model for production and launch of supplement which is constructed according to the process for production and launch of supplement of the ground subsystem. The two subsystems (space subsystem and ground subsystem) are connected by sharing a place to obtain a navigation constellation STPN model. According to the number of on-orbit and ground spare satellites, and the launch mode of the spare satellites, the present disclosure allows a design of different spare strategies and establishes a navigation constellation STPN model.

Specifically, the step of constructing a single satellite STPN model and an orbital plane STPN model, and establishing a navigation constellation STPN model including multiple spare strategies according to the single-satellite STPN model and the orbital plane STPN model comprises the following step:

in step S11, based on the actual operation information of the constellation system, presetting information of an initialization phase and information of an operation maintenance phase of the constellation.

In this implementation, the medium-orbit Walker navigation constellation is used as a modeling object for interpretation. This constellation is composed of 24 satellites, of which the constellation parameters are 24/3/1, the orbital altitude is 21,528 km, and the inclination angle is 55°; based on this, the proposed preset information is:

the information of an initialization phase is:

(1) in the constellation netting deployment, there are enough satellites and carrier rockets on the ground, and each launch adopts a launch mode of one rocket with two satellites, and a deployment of satellites on three orbital planes is completed every 4 months;

(2) the operation time of the system starts from the completion of constellation netting, and each orbital plane has the same state and the same number of spare satellites at the initialization of the system; and

(3) each orbital plane in the constellation can be at most deployed with 2 on-orbit spare satellites, and they are all in a cold spare state, that is, the malfunction rate is 0, and only in a normal operation mode can it have a limited service life; and the information of an operation maintenance phase is:

(1) the on-orbit spare satellites have completed an on-orbit test before working satellites malfunction, and the spare satellites will be directly connected to the constellation after the malfunctioning satellites are replaced;

(2) when there is a request for replacement of multiple malfunctioning satellites on orbit, the on-orbit spare satellites and the spare satellites on the ground will supplement the net one by one according to a priority order of occurrences of malfunctions; and

(3) the ground carrier rocket and satellite production line can only accept a production request once at a time, with only one carrier rocket or one satellite produced at a time, and the carrier rocket may be launched with up to 2 satellites at the same time.

It should be noted that the above-mentioned information of an initialization phase and information of an operation maintenance phase can be adaptively adjusted according to the type of an actually-modeled navigation satellite. The present disclosure includes but is not limited to the above assumptions.

In step S12, malfunctions that occur during the lifetime of the satellite and a repair mode are determined; and the single satellite STPN model is constructed according to the repair mode, and the information of an initialization phase and the information of an operation maintenance phase;

In this implementation, in the single satellite STPN model, the forms of satellite malfunctions include a short-term malfunction, a maintenance malfunction and a long-term malfunction; when the satellite suffers from a short-term malfunction or a maintenance malfunction, the satellite is repaired; and when the satellite suffers from a long-term malfunction, the satellite is replaced with a spare satellite.

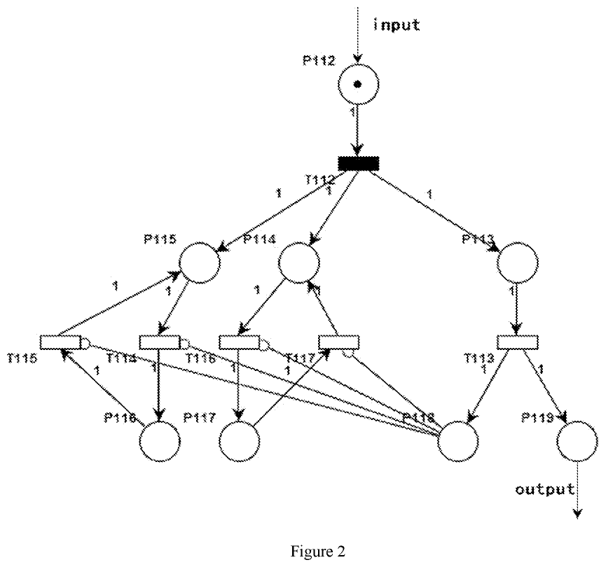

Specifically, FIG. 2 shows a schematic diagram of a single satellite STPN model with a medium-orbit Walker navigation constellation as a modeling object according to an exemplary embodiment of the present disclosure. The meanings of each place and transition in this single satellite STPN model are as shown in Table 1:

TABLE 1

| Place | Meaning | Transition | Meaning |
|---|---|---|---|
| P112 | In a normal | T112 | Tiggering a |
| | operation | | malfunction |
| P113 | Tiggering a | T113 | Suffering from |
| | long-term | | a long-term |
| | malfunction | | malfunction |
| P114 | Tiggering a | T114 | Suffering from |
| | maintenance | | a short-term |
| | malfunction | | malfunction |
| P115 | Tiggering a | T115 | Suffering from |
| | short-term | | a maintenance |
| | malfunction | | malfunction |
| P116 | Short-term | T116 | Repairing a |
| | malfunction | | maintenance |
| | | | malfunction |
| P117 | Maintenance | T117 | Repairing a |
| | malfunction | | short-term |
| | | | malfunction |
| P118 | Long-term | | |
| | malfunction | | |
| P119 | Request for | | |
| | replacement | | |

The single satellite STPN model with a medium-orbit Walker navigation constellation as a modeling object is described in combination with FIG. 2 as follows:

With reference to FIG. 2, the satellite is in a normal operation state at the initial time of constellation operation. There is a token in the place P112, and meanwhile the satellite will be in a malfunction triggering state. Therefore, after the instantaneous transition T112, there will be a token in P113, P114 and P115. If the satellite malfunctions after a certain period of operation, the satellite suffers from malfunction. The malfunction may be a short-term malfunction, a maintenance malfunction or a long-term malfunction. When the satellite suffers from a short-term malfunction T114 or a maintenance malfunction T116, the satellite will undergo a period of the repair process. Furthermore, when the satellite suffers from a long-term malfunction T113, a spare satellite will be needed for replacement, and meanwhile, there will be a token in P118 to prevent the occurrence of other transitions in the satellite.

In step S13, an orbital plane STPN model is constructed according to the way in which the malfunctioning satellite is replaced with an on-orbit spare satellite and the way in which the orbit sends a launch request to the ground system.

In this implementation, the orbital plane STPN model includes a preset number of working satellites and on-orbit spare satellites. When the working satellites fail, the on-orbit spare satellites replace the working satellites.

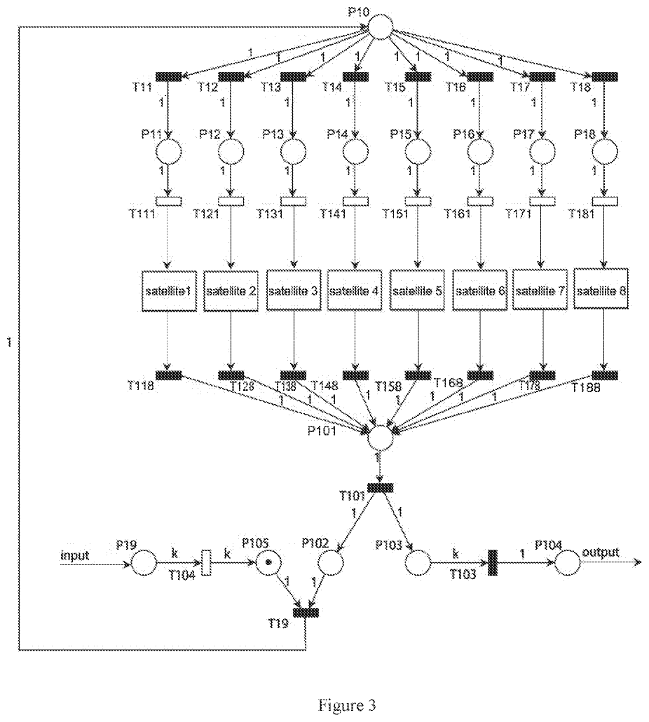

Specifically, in the orbital plane STPN model, each orbital plane will consist of 8 working satellites and on-orbit spare satellites. When a working satellite fails and cannot operate normally, the spare satellite will replace it to ensure the service performance of the constellation. FIG. 3 shows a single orbital plane STPN model with a medium-orbit Walker navigation constellation as a modeling object according to an exemplary embodiment in the mode of implementation of the present disclosure. The meanings of each place and transition in this single orbital plane STPN model are as shown in Table 2:

TABLE 2

| Place | Meaning | Transition | Meaning |
|---|---|---|---|
| P10 | Spare satellites | T11, T12, T13, | Selecting |
| | are waiting for | T14, T15, T16, T17 | malfunctioning |
| | replacement | and T18 | satellites |
| P11, P12, P13, | Deciding to | T111, T121, | Replacing |
| P14, P15, P16, P17 and P18 | replace | T131, T141, T151, | malfunctioning satellites |
| | malfunctioning | T161, T171 and | |
| | satellites | T181 | |
| P19 | Spare satellites | T118, T128, | Sending a |
| | come into orbit | T138, T148, T158, | request for |
| | | T168, T178 and | repalcement |
| | | T188 | |
| P101 | The totoal | T19 | Obtaining spare |
| | number of the | | satellites |
| | request for | | |
| | replacment | | |
| P102 | Replacment | T101 | Receving a |
| | command | | replacement |
| | | | command |
| P103 | The totoal | T103 | Sending a |
| | number of the lanuch | | lanuch request |
| | requests | | |
| P104 | Lanuch request | T104 | On-orbit test of |
| | | | the spare satellites |
| P105 | On-orbit spare | | |
| | satellites complete | | |
| | the test | | |

The orbital plane STPN model with a medium-orbit Walker navigation constellation as a modeling object is described in combination with FIG. 3 as follows:

With reference to FIG. 3, if the on-orbit spare satellites are deployed on the orbital plane at the initial time of the constellation, there will be the same number of tokens in the place P105 as that of the on-orbit spare satellites. When the satellite sends a request for replacement, a token will appear in P101, and meanwhile through an instantaneous transition T101 a replacement command is sent to the on-orbit spare satellite. The spare satellite will selectively do replacements according to the occurrence order of satellite malfunctions. Taking satellite 1 as an example, when the spare satellite selects satellite 1 for replacement, a token will appear in the place P11, and the replacement is completed through the time transition T111. k in FIG. 3 represents a launch mode of the carrier rocket. When one rocket with one satellite is adopted, k is 1, and when one rocket with two satellites is adopted, k is 2. The model assumes that when the number of the failure satellite on the orbital plane reaches k, the model sends a launch request to the ground system.

In step S14, the orbital plane STPN model is constructed according to the single satellite STPN model and the orbital plane STPN model.

In this implementation, the single satellite STPN model and the orbital plane STPN model constructed in step S12 and step S13 constitute a space subsystem. The method further includes: forming the ground subsystem according to the model of production and launch of supplement constructed by the process for production and launch of supplement of the ground subsystem, and connecting two subsystems by sharing a place.

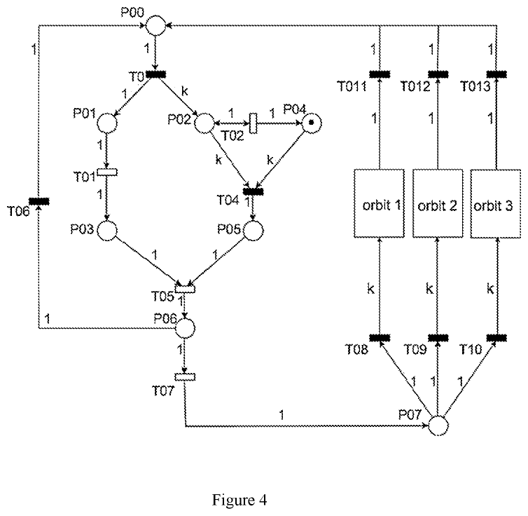

Specifically, FIG. 4 shows a navigation constellation STPN model with a medium-orbit Walker navigation constellation as a modeling object according to an exemplary embodiment in the mode of implementation of the present disclosure. The meanings of each place and transition in this navigation constellation STPN model are as shown in Table 3:

TABLE 3

| Place | Meaning | Transition | Meaning |
|---|---|---|---|
| P00 | The total | T0 | Receiving a |
| | number of the lanuch | | launch command |
| | requests | | |
| P01 | Command of | T01 | Producing a |
| | producing a carrier | | carrier rocket |
| | rocket | | |
| P02 | Command of | T02 | Producing a |
| | producing a satellite | | satellite |
| P03 | Completing the | T04 | Obtaining a |
| | production of a | | satellite |
| | carrier rocket | | |
| P04 | Inventory on | T05 | Final assembly |
| | the ground | | test |
| P05 | A satellite is | T06 | sending a launch |
| | waiting for launch | | request again |
| P06 | Completing the | T07 | Lauching a |
| | final assembly test | | satellite |
| P07 | Satellite | T011, T012 | Obtaining a |
| | launching is | and T013 | launch request |
| | successful | | |
| | | T08, T09 | Selecting an |
| | | and T010 | orbital plane |

The navigation constellation STPN model with a medium-orbit Walker navigation constellation as a modeling object is described in combination with FIG. 4 as follows:

With reference to FIG. 4, when a launch request is sent from any orbital plane, the place P00 will be labeled, and the production of k satellites and one carrier rocket will be allowed. If there are spare satellites on the ground stored in the inventory, there will be a corresponding number of tokens in the place P04. Furthermore, only when the number of the spare satellites on the ground meets the launch request, k satellites will be allowed to be launched, and otherwise the production will continue. If the satellite launch fails, another launch request will be automatically sent to P00. If the launch is successful, a token is placed in P07. The token indicates that there are k satellites available for one orbital plane, and the orbit selection is performed according to the priority order of launch requests.

Based on this, a three-layer overall STPN model of a single satellite, an orbital plane, and a navigation constellation is obtained. This model will be evaluated subsequently. In consideration of two spare strategies, namely an on-orbit spare and a ground spare, as well as various deterministic factors and stochastic factors of system operation, a navigation constellation STPN model with three levels is established, which can more accurately describe the characteristics of the internal logical structure of the constellation and the supply process of spare parts.

In step S2, an availability model is established according to the number of malfunctioning satellites and the constellation value (CV) in the navigation constellation STPN model, and a cost model is established according to the operating costs of the navigation constellation STPN model.

In this implementation, for the constellation adopting different spare strategies, evaluation indexes during the constellation operation are quantitative data for describing the spare strategies, and also provide a constellation manager with a basis for an optimization design of the constellation spare strategies. Based on this, in the present disclosure, the corresponding models are established to evaluate the constellation spare strategies from two aspects of the availability of the constellation and the operating costs of the system.

In step S21, the state level of the navigation constellation STPN model is determined according to the number of satellites in different malfunction forms in the navigation constellation STPN model, and the state of the constellation is determined according to the state level.

In this implementation, the availability which is one of important indexes of the constellation system, is mainly used for analyzing the time percentage during which the service performance provided by the constellation system meets the specific needs of a user. For a satellite navigation system, its availability analysis is mainly measured by navigation system precision (NSP). Furthermore, the precision not only is affected by a ranging error of the user, but also depends on the state of the constellation. Different constellation states will cause a change in the constellation space configuration, thereby affecting the precision. Based on this, firstly, the state levels of the constellation are classified according to the number of malfunctioning satellites in the constellation. It should be noted that the malfunctioning satellites in the present disclosure include satellites under different malfunction modes, but not only refer to satellites that suffer from a long-term malfunction. The state levels of the constellation are indicated as follows:

P₁: there are no malfunctioning satellites in the constellation, and at this moment the constellation is in a normal state;

P₂: there is 1 malfunctioning satellite in the constellation;

P₃: there are 2 malfunctioning satellites in the constellation;

P₄: there are 3 malfunctioning satellites in the constellation; and

P₅: the number of malfunctioning satellites in the constellation is greater than 3.

Secondly, according to the above-mentioned state levels of the constellation, a CV (Constellation Value) of the constellation is selected as an objective function to evaluate the performance of different constellation states. The CV of the constellation which serves as an important index to measure the coverage performance of the constellation in a designated service area, can reflect geometric characteristics of the constellation and availability of a constellation precision factor under a specific threshold. The present disclosure calculates the CV of the navigation constellation STPN model according to a formula (1):

$$. CV = \frac{{\sum }_{t = {t}_{0}}^{{t}_{0} + Δ T} {\sum }_{i = 1}^{L} bool ( P D O {P}_{t , i} \leq T {h}_{D O P} ) \times a r e {a}_{i}}{Δ T \times {\sum }_{i = 1}^{L} are {a}_{i}} \qquad ( 1 )$$

wherein, the global service area is divided into grids according to the preset mode; t₀ is initial time; ΔT is total simulation time; PDOP_{t,i} is a PDOP value (Position Dilution of Precision) of the grid point i at time t; Th_{DOP} is a threshold of the precision factor; bool( ) is Boolean function; L is the total number of grid points; and areaᵢ is the area of grid point i.

It should be noted that if three or more satellites malfunction on the orbital plane, the service availability of the constellation will be interrupted. However, this situation is usually impossible. The probability that multiple satellites simultaneously malfunction in the constellation is also very small Thus, the present disclosure only calculates a CV of the navigation constellation when the malfunctioning satellites in P₁, P₂, P₃, and P₄ are on different orbital planes.

In the present disclosure, the above-mentioned model established using a medium-orbit Walker navigation constellation as a modeling object is taken as an example. Taking the world as a service area and PDOP [symbol] 4 as a requirement, and dividing the global service area into grids according to the 5°×5° longitude and latitude lines, with the calculation time of one week constellation regression cycle, the step length of 300s, and the minimum observation elevation angle of 5°, the CV of the constellation corresponding to each state level is calculated. The results are as shown in Table 4.

TABLE 4

| | P1 | P2 | P3 | P4 |
|---|---|---|---|---|
| Maximum | 100% | 100% | 99.98% | 99.73% |
| value | | | | |
| Minimum | 100% | 100% | 99.30% | 96.01% |
| value | | | | |

Based on this, in order to evaluate the service availability of the navigation constellation system, according to the state of the constellation and the CV of the constellation obtained according to the formula (1), an availability model is established:

$$A = {\sum }_{k = 1}^{N} {P}_{k} \cdot {CV}_{k} \qquad ( 2 )$$

wherein, k is type k of the constellation state; N is the total number of constellation states; Pₖ is the occurrence probability of the constellation in the state k; and CVₖ is a CV of the constellation when the constellation is in the state k.

It should be noted that the occurrence probability is a ratio of the time of the constellation state to the total operation time, which is obtained by Monte Carlo simulation.

In addition, the present disclosure can also determine a state of the constellation according to the state level. Specifically, the average service availability of the navigation system in the global area with a position precision factor less than or equal to 4 is greater than or equal to 95%. From the above calculation of the CV, it can be seen that the CVs of the constellation when the constellation is in the states P₁, P₂, and P₃ are ≥99%. For the convenience of analysis, these three states are collectively referred to as S₁, and meanwhile the state S₁ or P₄ of the system is referred to as S₂. Since the minimum CV of the state S₂ meets the requirement of greater than 95%, the minimum requirement of the constellation spare strategy is proposed: the probability of the constellation getting to S₂ during operation is better than 95%. At the same time, in order to ensure the system to achieve the availability requirement during operation, on the basis of satisfying the state S₂, it is further proposed: it requires 98% of the time to achieve the requirement of the state S₁, that is, the probability of the constellation getting to S₁ during operation is better than 93%, that is, the threshold requirement of the constellation spare strategy is: during operation, the probability of the constellation getting to S₁ is greater than 93%.

In step S22, a cost model is established according to the operating costs of the navigation constellation STPN model.

In this implementation, the operating costs include an inherent cost, a supplement cost, a storage cost, and a shortage cost; wherein, the inherent cost refers to the cost in the constellation netting deployment phase, and the inherent cost will be different for different spare strategies. The supplement cost refers to the manufacturing cost of satellites and carrier rockets as well as the launch cost of satellites during the operation phase. The storage cost refers to the storage cost incurred by the inventory before the launch of the spare satellites on the ground. The shortage cost refers to the economic loss caused by the failure to replace the malfunctioning satellites in the constellation. For the convenience of analysis, regarding the inherent cost, the present disclosure only considers the cost of the spare satellites on the ground and the deployment of on-orbit spare satellites in the spare strategy.

Specifically, the cost model established by the present disclosure is as shown in formula (3):

$$Cost = c \cdot [ {\sum }_{i = 1}^{j} ( {t}_{i} - {t}_{i - 1} ) \cdot {M}_{i - 1} + ( T - {t}_{j} ) \cdot {M}_{j} ] + v \cdot [ {\sum }_{k = 1}^{n} ( {t}_{k} - {t}_{k - 1} ) \cdot {K}_{k - 1} + ( T - {t}_{n} ) \cdot {K}_{n} ] + R + Q \qquad ( 3 )$$

wherein, the inherent cost Q is: K·x+3·(y+S·x+S·z); the supplement cost R is: s·x+h·y+l·z; assuming that the system undergoes a satellite production transition at time tₖ, and a satellite launch transition at time tₖ₋₁, the corresponding storage cost is: Kₖ₋₁ (tₖ−tₖ₋₁)·v,k=1, 2, . . . n; assuming that the system undergoes a satellite replacement transition at time tᵢ, and a satellite malfunction transition at time tᵢ₋₁, the corresponding shortage cost is: Mᵢ₋₁·(tᵢ−tᵢ₋₁)·c,i=1, 2, . . . j; and

wherein, X is a satellite cost; y is a carrier rocket cost; z is a launch cost of a single satellite; v is a storage cost of a single satellite per hour; C is a shortage cost of a single satellite per hour; t₀ is initial time of operation; the number of spare satellites on the ground at time t₀ is K; the number of on-orbit spare satellites at each orbital plane is S; s is the number of satellites produced; h is the number of carrier rockets produced; l is the total number of launched satellites; the production or launch time of satellite k is tₖ; the number of spare satellites on the ground at time tₖ is Kₖ; n is the total number of satellite production and launch events; the replacement or malfunction time of the satellite i is tᵢ; the number of malfunctioning satellites in the constellation at time tᵢ is Mᵢ; j is the total number of satellite replacement and malfunction events; and T is operating time of the system.

Based on this, a multi-constraint model of the constellation in the operation phase is established, including an availability model and a cost model, which provides a standard for the evaluation of the navigation constellation STPN model and the determination of the target spare strategy in comprehensive consideration of the availability and operation costs of the constellation.

In step S3, the navigation constellation STPN model is evaluated using the availability model and the cost model, and a target spare strategy is determined from the multiple spare strategies according to an evaluation result.

In this implementation, the multiple spare strategies include: an on-orbit spare strategy, a ground spare strategy, and a combination strategy of the two spare strategies; based on the Monte Carlo method, the present disclosure evaluates the navigation constellation STPN model using the availability model and the cost model, and determines a target spare strategy from the multiple spare strategies according to an evaluation result, specifically:

firstly, the availability of the navigation constellation STPN model is evaluated using the availability model;

Secondly, candidate spare strategies that meet the availability model in the navigation constellation STPN model are reevaluated using the cost model; and

finally, a target spare strategy is determined from the candidate spare strategies based on an evaluation result of the cost model; wherein the multiple spare strategies include: an on-orbit spare strategy, a ground spare strategy and a combination strategy of the two spare strategies; according to different numbers of spare satellites and different launch modes for spare satellites, the navigation constellation STPN model is evaluated using the availability model and the cost model;

wherein, the target spare strategy meets the availability and has a minimum operating cost.

Specifically, before evaluating the navigation constellation STPN model, assuming that the reliability of the satellite is 0.6 when the satellite reaches the end of its lifetime of 10 years, and the stochastic malfunction of the satellite follows a Weibull distribution, and the loss malfunction follows a normal distribution, a reliability model of the navigation satellite is constructed:

$$R ( t ) = {e}^{- {( t / α )}^{β}} \cdot {\int }_{t}^{∞} \frac{1}{\sqrt{2 π} σ} {e}^{\frac{{( t - μ )}^{2}}{2 {σ}^{2}}} dt \qquad ( 1 )$$

wherein, α is a scale parameter; β is a shape parameter; μ is a mean value; σ is a standard deviation; and t is working time of the satellite.

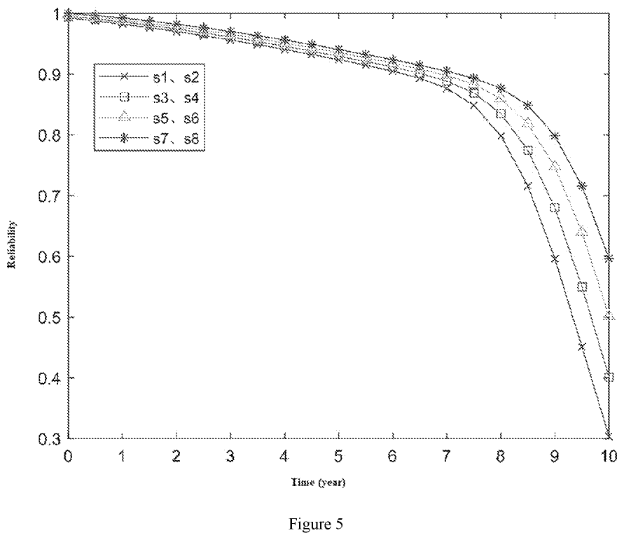

According to lifetime design requirements and actual operating conditions of the navigation satellites, assuming that the parameters of the Weibull distribution and the normal distribution are as shown in Table 5. Since the model is assumed to complete a satellite deployment every 4 months, the reliability of each satellite on orbit when the system completes the netting can be obtained. The reliability of the satellite as a function of time is as shown in FIG. 5. It can be seen from FIG. 5 that the earlier the satellite is launched, the lower the reliability of the system at the beginning of operation is, and the reliability is relatively stable during the lifetime, but it drops sharply after the end of lifetime.

TABLE 5

| Parameter | Value/year |
|---|---|
| Scale parameter | 33.8 |
| Shape parameter | 1.46 |
| Mean value | 10.6 |
| Standard deviation | 1.1 |

The type and rate parameters of other time transitions in the model are as shown in Table 6.

TABLE 6

| Transition | Type | Parameter/hour | Transition | Type | Parameter/hour |
|---|---|---|---|---|---|
| T114 | Exponential | λ = 1.1e−4 | T104 | Determination | t = 2160 |
| | distribution | | | distribution | |
| T115 | Determination | t = 12 | T01 | Determination | t = 8760 |
| | distribution | | | distribution | |
| T116 | Poisson | λ = 4.6e−5 | T02 | Determination | t = 17520 |
| | distribution | | | distribution | |
| T117 | Determination | t = 3 | T05 | Determination | t = 1080 |
| | distribution | | | distribution | |
| T111, T121, | Determination | t = 168 | T07 | Determination | t = 4 |
| T141, T151, | distribution | | | distribution | |
| T161, T171 | | | | | |
| and T181 | | | | | |

Based on this, assuming that the simulation time is 10 years and the launch success rate is 0.97, the 10³ simulations are conducted on the navigation constellation STPN model with different spare strategies according to the Monte Carlo method. The simulation results are as follows:

(1) Analysis of Ground Spare Strategies

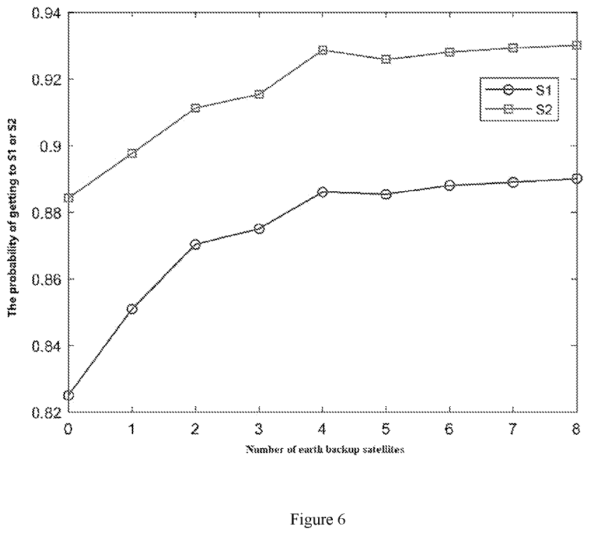

A ground spare strategy means that when the satellites in the constellation fail, the net will be supplemented by launching satellites from the ground, which belongs to an on-demand launch. The availability analysis is carried out for the case in which there are no on-orbit spare satellites and the number of spare satellites on the ground is 0 to 8. The results are as shown in FIG. 6.

It can be seen from FIG. 6 that when no spare strategy is adopted, that is, when the number of spare satellites on the ground is 0, the probabilities of the constellation getting to the S₁ and S₂ states are only 82.51% and 88.43%, respectively, which cannot meet the requirements on the performance of the constellation. When the number of spare satellites increases, the probabilities of getting to the S₁ and S₂ states are greatly improved compared with the case without spare satellites. At the same time, with the number of spare satellites increasing, the probability also gradually increases. Furthermore, when the number of spare satellites reaches 4, the probability tends to be stable. When the number of spare satellites is finally 8, the probabilities are 89.01% and 93.01%, respectively, both of which do not achieve the design requirements. Therefore, in the case that spare satellites on the ground are only considered, the performance requirement of the average service availability being greater than or equal to 95% cannot be achieved.

(2) Analysis of On-Orbit Spare Strategies

An on-orbit spare strategy means that spare satellites are deployed on the working orbit. When the satellites on the same orbital plane fail, the spare satellites are used to quickly replace them, and after the spare satellites replace the failed satellites, satellites are then supplementarily launched from the ground.

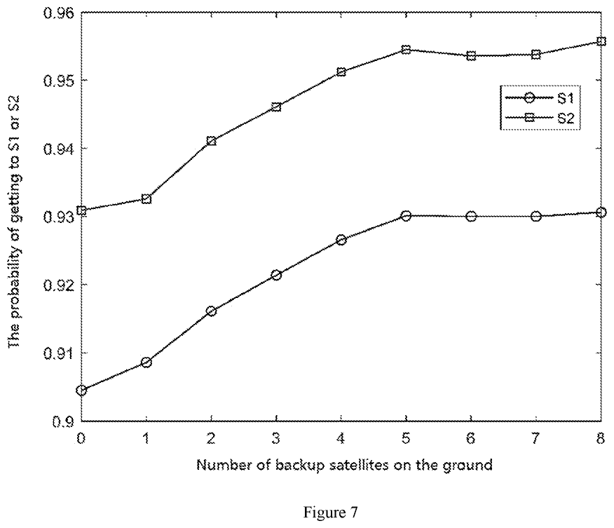

In the case that on each orbital plane, there is one on-orbit spare and the number of spare satellites on the ground is 0 to 8, the analysis of availability is performed by using the launch mode of one rocket with one satellite. The results are as shown in FIG. 7.

It can be seen from FIG. 7 that the service availability of the constellation has been greatly improved after one spare satellite on orbit is arranged for each orbital plane. At the same time, compared with a single spare strategy, the service availability by combining two spare strategies has also been significantly improved. With the number of spare satellites on the ground increasing, the probability that can be achieved also gradually increases. When the number of spare satellites reaches 5, the probability tends to be stable. At this time, the probabilities of getting to the S₁ state and the S₂ state are 93.01% and 95.45%, respectively. It can meet the design requirement on the average service availability of the constellation.

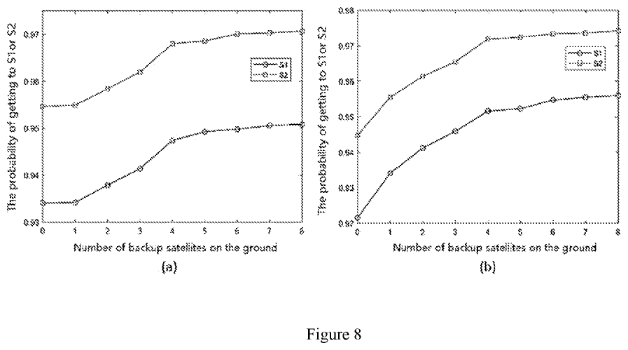

In the case that on each orbital plane there are two on-orbit spare satellites and the number of spare satellites on the ground is 0 to 8, the analysis of availability is performed by using the launch modes of one rocket with one satellite and one rocket with two satellites for the spare satellites on the ground. The results are as shown in FIG. 8.

It can be seen from FIG. 8 that when two spare satellites on orbit are arranged for each orbital plane and a launch mode of one rocket with one satellite (a) is adopted, the only use of the on-orbit spare strategy can meet the design requirement on the average service availability. At this time, the probabilities of getting to the S₁ state and the S₂ state are 93.41% and 95.47%, respectively. Furthermore, when a launch mode of one satellite with two satellites (b) is adopted, since there are no spare satellites on the ground, the supplementary launch of the on-orbit spare satellites needs to wait for the production of two satellites. Thus, a single spare strategy cannot meet the design requirement. With the number of spare satellites on the ground increasing, the probabilities for two launch modes have increased. However, since one rocket with two satellites can achieve the quick supplement of the on-orbit spare satellites, under the same conditions, the probability for getting the state of satisfying the service availability is generally greater than that of the launch mode of one rocket with one satellite. At the same time, when the number of spare satellites on the ground reaches 4, the probabilities under two launch modes tend to be stable.

Further, the candidate spare strategies that meet the availability model in the navigation constellation STPN model are evaluated again using the cost model, assuming that the cost parameters in the cost model are as shown in Table 7, since the shortage cost is difficult to be accurately evaluated in practice, sensitivity analysis is performed on said value with the estimated values of 50,000, 200,000, 500, 000 and 1,000,000 selected respectively.

TABLE 7

| Cost | Value/ten thousand |
|---|---|
| Satellite cost | 20000 |
| Carrier rocket cost | 5000 |
| Sinle satellite luaching | 6000 |
| cost | |
| Storage cost of a single | 2 |
| satellite per hour | |

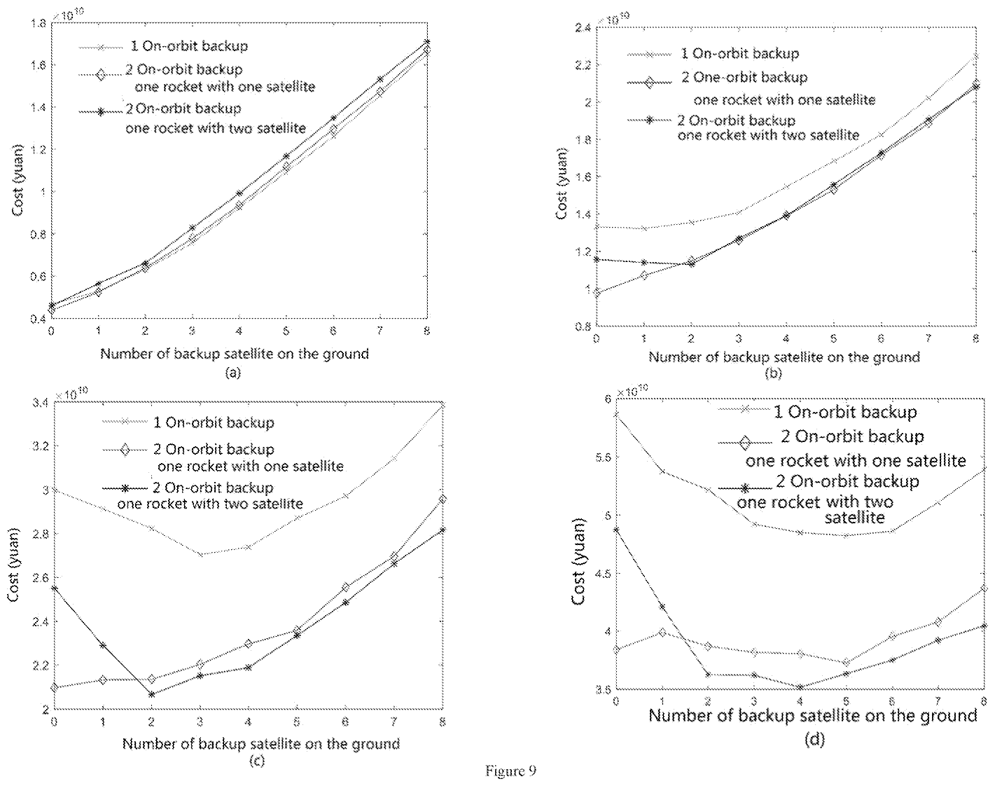

Based on the above simulation results, it can be obtained that only the ground spare strategy cannot meet the design requirement on the average service availability of the constellation. Therefore, only the operating costs of the constellation with an on-orbit spare strategy are simulated and analyzed. The results are as shown in FIG. 9.

It can be seen from FIG. 9 that there is a direct relationship between the shortage cost and the operating costs of the system. With the shortage cost increasing, the operating costs of the constellation will also increase. Due to the performance difference that different on-orbit spare strategies can meet, when the shortage cost is relatively small, the cost gap caused by different strategies is also relatively small. At this time, the cost gap is mainly caused by the inherent cost and the supplement cost, as shown in FIG. 9 ((a) is the shortage cost 50,000 of a single satellite per hour; and (b) is the shortage cost 200,000 of a single satellite per hour of). When the shortage cost gradually increases, the cost difference caused by different strategies also gradually increases, and the cost caused by the on-orbit spare strategy having better performance is gradually in a relatively low level.

An increase in the number of spare satellites on the ground can improve the performance level of the constellation system, thereby reducing the shortage cost, but also increasing the inherent cost and the storage cost. When the shortage cost is relatively low, the operating costs will increase with the increase in the number of spare satellites on the ground. Furthermore, when the shortage cost increases to a certain extent, the reduction in the shortage cost of the system caused by the improvement of the performance level is greater than the increase in the inherent cost and the storage cost, and the costs will have a downward trend, as shown in FIG. 9 ((c) is the shortage cost of a single satellite per hour of 500,000; and (d) is the shortage cost of a single satellite per hour of 1 million). At this time, the shortage cost gradually becomes a dominant factor affecting the costs. Subsequently, when an increase in the number of spare satellites on the ground cannot significantly enhance the performance, the costs of the system will continue to increase with the increase in the number of spare satellites. This law of change shows numerically that when the shortage cost increases, the cost model has an extreme point, and an optimal spare strategy can be obtained based on this.

Finally, based on an evaluation result of the cost model, a target spare strategy is determined from the candidate spare strategies. The present disclosure proposes a method of determining an optimal spare strategy that minimizes the operating costs of the system under the premise of meeting the availability. The finally obtained optimal spare strategies and parameters under different conditions are as shown in Table 8.

TABLE 8

| | Optimal spare strategy | | | |
|---|---|---|---|---|
| Shortage | On-orbit | Ground | | Operating |
| cost/ten | spare on each | spare/ | Launch | costs/ten |
| thousand | orbit/number | number | mode | thousand |
| 5 | 2 | 0 | One rocket | 4.39e5 |
| | | | with | |
| | | | onesatellite | |
| 20 | 2 | 0 | One rocket | 9.76e5 |
| | | | with one | |
| | | | satellite | |
| 50 | 2 | 2 | One rocket | 2.07e6 |
| | | | with two | |
| | | | satellites | |
| 100 | 2 | 4 | One rocket | 3.52e6 |
| | | | with two | |
| | | | satellites | |

The present disclosure provides a method of evaluating a navigation constellation spare strategy based on a stochastic time Petri net. The method is provided for an on-orbit spare strategy, a ground spare strategy and a combination of the two spare strategies, according to the number of on-orbit and ground spare satellites as well as a launch mode of spare satellites. The method allows a design of different spare strategies and has stronger flexibility, and can fully evaluate the impact of different spare strategies on the operating parameters of the constellation. At the same time, this method establishes a more real operation maintenance model of the constellation system to improve the accuracy of spare strategy evaluation by considering stochastic and definite events such as satellite malfunctions, satellite replacements, satellite launch, and satellite and carrier rocket production in the constellation. This method comprehensively considers the availability of the constellation and the operating costs of the system to obtain an optimal spare strategy of the constellation under different conditions according to a standard of the minimum costs on the basis of meeting the availability, which provides an example for the design of the navigation constellation spare strategy.

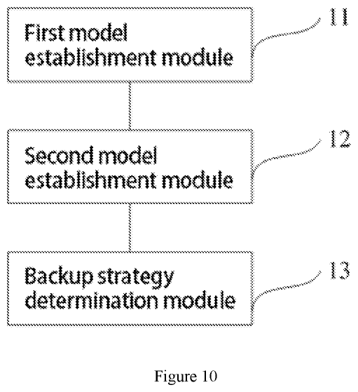

The present disclosure also provides a system of evaluating a constellation spare strategy based on a stochastic time Petri net. FIG. 10 shows a structural block diagram of the system of evaluating a constellation spare strategy based on a stochastic time Petri net. The system comprises:

a first model establishment module 11, for constructing a single satellite STPN model and an orbital plane STPN model, and establishing a navigation constellation STPN model that includes multiple spare strategies according to the single satellite STPN model and the orbital plane STPN model;

a second model establishment module 12, for establishing an availability model according to the number of malfunctioning satellites and the constellation CV in the navigation constellation STPN model, and establishing a cost model according to the operating costs of the navigation constellation STPN model; and

a spare strategy determination module 13, for evaluating the navigation constellation STPN model using the availability model and the cost model, and determining a target spare strategy from the multiple spare strategies according to an evaluation result.

For the specific description of each module in the above evaluation system, it may refer to the description of each step in the evaluation method, and it will not be repeated here. The above evaluation system can achieve the same functions as those of the evaluation method.

The above description merely relates to embodiments of the present disclosure but do not limit in any form to the present disclosure. Although the present disclosure is disclosed as above with better embodiments, they are not intended to limit the present disclosure. Some changes or modifications made by anyone skilled in the art without departing from the technical solutions in the present disclosure are equivalent to equivalent implementations and they all fall within the scope of the present disclosure. The description and the embodiments are only regarded as exemplary, and the true scope and spirit of the present disclosure are defined by the appended claims.

1. A method of evaluating a constellation spare strategy based on a stochastic timed Petri net (STPN), comprising:
constructing a single satellite STPN model and an orbital plane STPN model, and establishing a navigation constellation STPN model which comprises multiple spare strategies according to the single satellite STPN model and the orbital plane STPN model;
establishing an availability model according to the number of malfunctioning satellites and the constellation value (CV) in the navigation constellation STPN model, and establishing a cost model according to operating costs of the navigation constellation STPN model; and
evaluating the navigation constellation STPN model using the availability model and the cost model, and determining a target spare strategy from the multiple spare strategies according to an evaluation result.

2. The method according to claim 1, wherein the single satellite STPN model and the orbital plane STPN model form a space subsystem, the method further comprising:
constructing a ground subsystem according to a process of production and launch of supplement; and
the establishment of the navigation constellation STPN model specifically comprising:
connecting the space subsystem with the ground subsystem by sharing a place to obtain the navigation constellation STPN model.

3. The method according to claim 1, wherein the construction of the single satellite STPN model and the orbital plane STPN model specifically comprises:
presetting information of an initialization phase and information of an operation maintenance phase of the navigation constellation STPN model based on actual operation information of the navigation constellation system;
determining malfunctions that occur during a lifetime of a satellite and repair modes, and constructing a single satellite STPN model according to the repair mode, and the information of the initialization phase and the information of the operation maintenance phase; and
constructing the orbital plane STPN model according to a mode of replacing a malfunctioning satellite with an on-orbit spare satellite and a mode of sending a launch request from the orbit to the ground system;
wherein, the orbital plane STPN model comprises a preset number of working satellites and on-orbit spare satellites; when the working satellites fail, the on-orbit spare satellites replace the working satellites.

4. The method according to claim 3, wherein the determination of malfunctions that occur during the lifetime of the satellite and the repair modes comprises:
performing a satellite repair, when the satellite suffers from a short-term malfunction or a maintenance malfunction, and
performing a replacement with a spare satellite when the satellite suffers from a long-term malfunction.

5. The method according to claim 4, wherein the establishment of the availability model according to the number of malfunctioning satellites and the CV in the navigation constellation STPN model specifically comprises:
determining a state level of the navigation constellation STPN model according to the number of satellites under different malfunction forms in the navigation constellation STPN model, and determining a state of the constellation according to the state level; and
calculating the CV of the navigation constellation STPN model according to a formula (1):
$$CV = \frac{{\sum }_{t = {t}_{0}}^{{t}_{0} + Δ T} {\sum }_{i = 1}^{L} bool ( P D O {P}_{t , i} \leq T {h}_{D O P} ) \times a r e {a}_{i}}{Δ T \times {\sum }_{i = 1}^{L} are {a}_{i}} \qquad ( 1 )$$
wherein, a global service area is divided into grids according to a preset mode; t₀ is initial time; ΔT is total simulation time; PDOP_{t,i} is a PDOP value (Position Dilution of Precision) of a grid point i at time t; Th_{DOP} is a threshold of the precision factor; bool( ) is Boolean function; L is a total number of grid points; and areaᵢ is an area of grid point i; and
establishing the availability model according to the state of the constellation and the CV of the constellation obtained according to the formula (1):
$$A = {\sum }_{k = 1}^{N} {P}_{k} \cdot {CV}_{k} \qquad ( 2 )$$
wherein, k is type k of the constellation state; N is the total number of constellation states; Pₖ is the occurrence probability of the constellation in the state k; and CVₖ is a CV of the constellation when the constellation is in the state k.

6. The method according to claim 5, wherein the state level comprises:
P₁: there are no malfunctioning satellites in the constellation, and at this moment the constellation is in a normal state;
P₂: there is 1 a malfunctioning satellite in the constellation;
P₃: there are 2 malfunctioning satellites in the constellation;
P₄: there are 3 malfunctioning satellites in the constellation; and
P₅: the number of malfunctioning satellites in the constellation is greater than 3;
preferably, the determination of the state of the constellation according to the state level specifically comprises:
determining that the constellation is in state S₁ when the constellation is at a state level of P₁, P₂ or P₃; and
determining that the constellation is in state S₂ when the constellation is at a state level of S₁ or P₄;
wherein, a threshold requirement of the constellation spare strategy is: during the operation, a probability of the constellation getting to S₂ is greater than 95%, and the probability of the constellation getting to S₁ is greater than 93%.

7. The method according to claim 1, wherein the operating costs comprise an inherent cost, a supplement cost, a storage cost and a shortage cost;
according to the operating costs of the navigation constellation STPN model, a cost model is established:
$$Cost = c \cdot [ {\sum }_{i = 1}^{j} ( {t}_{i} - {t}_{i - 1} ) \cdot {M}_{i - 1} + ( T - {t}_{j} ) \cdot {M}_{j} ] + v \cdot [ {\sum }_{k = 1}^{n} ( {t}_{k} - {t}_{k - 1} ) \cdot {K}_{k - 1} + ( T - {t}_{n} ) \cdot {K}_{n} ] + R + Q \qquad ( 3 )$$
wherein, the inherent cost Q is: K·x+3·(y+S·x+S·z); the supplement cost R is: s·x+h·y+l·z; assuming that the system undergoes a satellite production transition at time tₖ, and a satellite launch transition at time tₖ₋₁, the corresponding storage cost is: Kₖ₋₁·(tₖ−tₖ₋₁)·v, k=1, 2, . . . n; assuming that the system undergoes a satellite replacement transition at time tᵢ, and a satellite malfunction transition at time tᵢ₋₁, the corresponding shortage cost is: Mᵢ₋₁·(tᵢ·tᵢ₋₁)·c, i=1, 2, . . . j; and
wherein, x is a satellite cost; y is a carrier rocket cost; z is a launch cost of a single satellite; v is a storage cost of a single satellite per hour; c is a shortage cost of a single satellite per hour; t₀ is initial time of operation; the number of spare satellites on the ground at time t₀ is K; the number of on-orbit spare satellites is S; S is the number of satellites produced; h is the number of carrier rockets produced; l is a total number of launched satellites; the production or launch time of satellite k is tₖ; the number of spare satellites on the ground at time tₖ is Kₖ; n is a total number of satellite production and launch events; the replacement or malfunction time of the satellite i is tᵢ; the number of malfunctioning satellites in the constellation at time tᵢ is Mᵢ; j is a total number of satellite replacement and malfunction events; and T is operating time of the system.

8. The method according to claim 1, wherein the evaluation of the navigation constellation STPN model using the availability model and the cost model, and the determination of the target spare strategy from the multiple spare strategies according to the evaluation result specifically comprise:
evaluating the availability of the navigation constellation STPN model using the availability model based on the Monte Carlo method;
reevaluating candidate spare strategies that meet the availability model in the navigation constellation STPN model using the cost model; and
determining the target spare strategy from the candidate spare strategies based on the evaluation result of the cost model;
wherein, the target spare strategy meets the availability and has a minimum operating cost.

9. The method according to claim 8, wherein the multiple spare strategies include an on-orbit spare strategy, a ground spare strategy, and a combination strategy of the two spare strategies; and
the navigation constellation STPN model is evaluated using the availability model and the cost model according to different numbers of spare satellites and different spare satellite launch modes.

10. A system of evaluating a constellation spare strategy based on a stochastic time Petri net, comprising:
a first model establishment module, configured to construct a single satellite STPN model and an orbital plane STPN model, and establish a navigation constellation STPN model that includes multiple spare strategies according to the single satellite STPN model and the orbital plane STPN model;
a second model establishment module, configured to establish an availability model according to the number of malfunctioning satellites and the CV in the navigation constellation STPN model, and establish a cost model according to the operating costs of the navigation constellation STPN model; and
a spare strategy determination module, configured to evaluate the navigation constellation STPN model using the availability model and the cost model, and determine a target spare strategy from the multiple spare strategies according to the evaluation result.
